(19) United States
(12) Patent Application Publication
(10) Pub. No.: US 2020/0109219 A1
(43) Pub. Date: Apr. 9, 2020

(54) PROCESS FOR PREPARATION OF SUGAMMADEX SODIUM

(71) Applicant: NEULAND PHARMA RESEARCH PRIVATE LIMITED, HYDERABAD (IN)

(72) Inventors: Ponnaiah Ravi, Madurai (IN); Yamma Ayyan Krishna Kumar Moorthi, Madurai (IN); Batthini Guruswamy, Hyderabad (IN); Ponnoju Vijay Bhaskar, Secunderabad (IN); Arutla Srividya, Jinnaram Mandai, Medak District (IN); Uppala Manikya Rao, Guntur (IN); Girish Arvind KAVISHWAR, Mumbai (IN); Anil Kumar SONI, Hyderabad (IN); Satishbhai MORE, Hyderabad (IN); Medida Venkata Rama Chandra MURTHY, Inavilli (Mandal) (IN); Patnala Sriramachandra MURTHY, Hyderabad (IN)

(21) Appl. No.: 16/500,829

(22) PCT Filed: Apr. 6, 2018
(86) PCT No.: PCT/IN2018/050197

§ 371 Date: Oct. 4, 2019

(30) Foreign Application Priority Data
Apr. 6, 2017 (IN) 201741012475

(51) Int. Cl. C08B 37/00; C08B 37/16

(52) U.S. Cl. CPC C08B 37/0003; C08B 37/0012

(57) ABSTRACT

An improved process for the preparation of Sugammadex sodium and its purification process thereof is provided.

### CROSS-REFERENCE TO RELATED APPLICATIONS

This application claims priority to PCT Application No. PCT/IN2018/050197, having a filing date of Apr. 6, 2018, based on IN 201741012475, having a filing date of Apr. 6, 2017, the entire both contents of which are hereby incorporated by reference.

### FIELD OF TECHNOLOGY

The following relates to an improved process for preparation of Sugammadex sodium and its purification thereof.

### BACKGROUND

Sugammadex sodium represented by compound of Formula I is an agent for reversal of neuromuscular blockade by the neuromuscular blocking agents (NMBAs) such as Rocuronium, Vecuronium or Pancuronium in general anesthesia. It is the first selective relaxant binding agent (SRBA). SRBAs are a new class of drugs that selectively encapsulates and binds NMBAs.

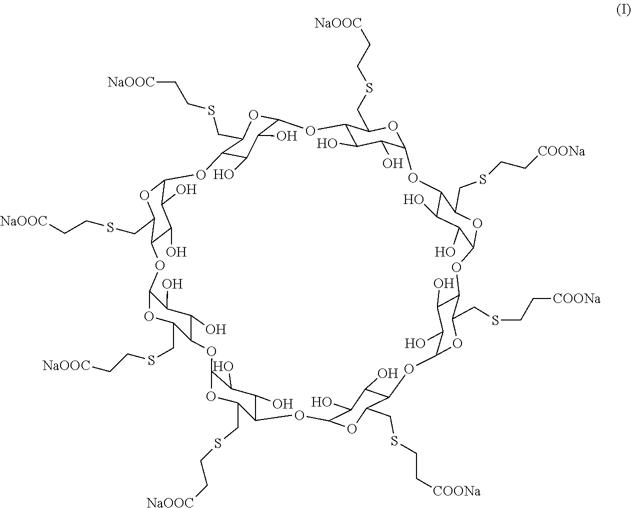

Purification is the major obstacle in the process for preparation of Sugammadex sodium. Purification techniques for Sugammadex sodium reported in U.S. Pat. No. RE44733 and International Publication Number WO2016/194001 employ column chromatographic techniques, membrane dialysis and preparative HPLC method, which are costly and not convenient in large scale operations. Therefore, the reported processes for preparation of Sugammadex sodium as discussed herein are time consuming and not economically and industrially viable.

Thus, there exists a need to provide a process of preparation of Sugammadex sodium which is simple, convenient, with easy work up procedure, economically efficient and the one which provides Sugammadex sodium in good yield and high purity.

### SUMMARY

An aspect relates to an improved process for preparation of Sugammadex sodium and its purification thereof.

In one aspect, embodiments of the present invention provides process for preparation of Sugammadex sodium of Formula I

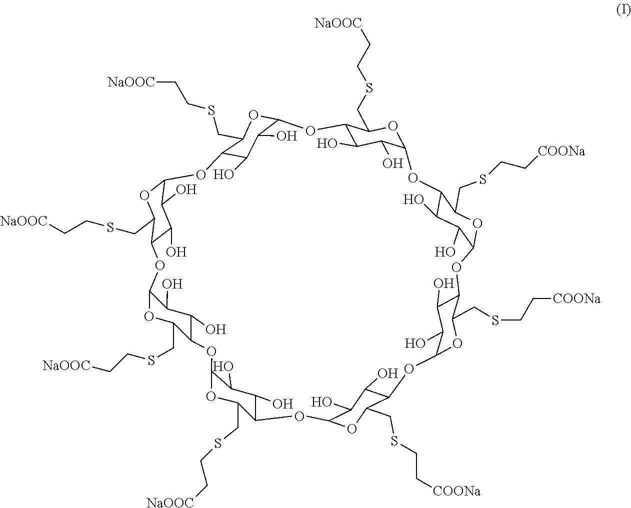

which comprises:
a) reacting gamma-cyclodextrin of Formula II

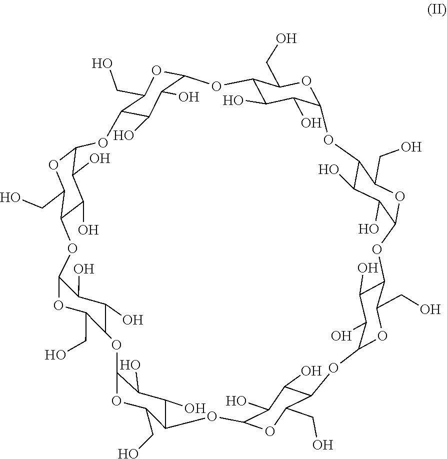 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]

with phosphorus pentachloride in dimethylformamide to obtain 6-perdeoxy-6-per-chloro gamma cyclodextrin of Formula III;

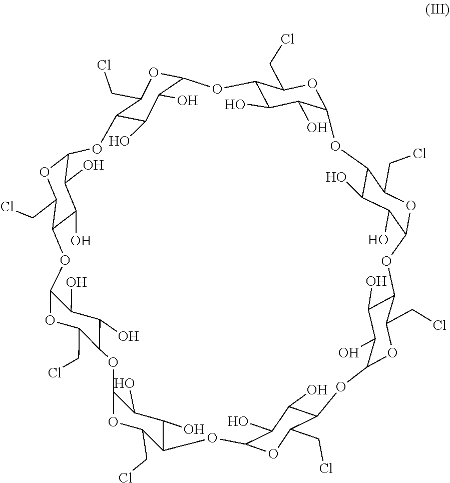 [SMILES: OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]

b) reacting compound of Formula III with 3-mercapto propionic acid of Formula IV

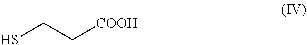

in dimethylformamide in the presence of 30% sodium methoxide in methanol to give Sugammadex Sodium of Formula I;
c) converting the obtained Sugammadex sodium into Sugammadex free acid of Formula V

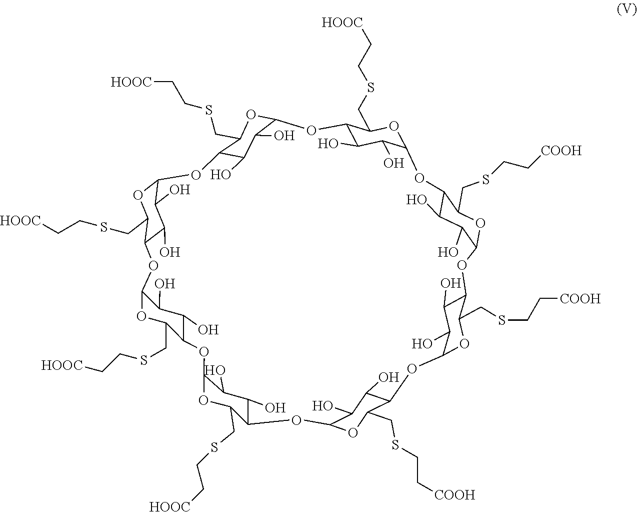 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

by adding acetic acid in the presence of water to obtain Sugammadex free acid;
d) purification of Sugammadex free acid obtained in step c) by preparative HPLC using silica column of C18 bulk media with 10 or 16 μm to obtain pure Sugammadex free acid in solution form;
e) distilling the obtained Sugammadex free acid solution in step d) to obtain solid pure Sugammadex free acid;
f) converting the obtained pure Sugammadex free acid obtained in step e) in to Sugammadex sodium by reacting Sugammadex free acid with sodium hydroxide in water and
g) lyophilization of Sugammadex sodium obtained in step f) to obtain pure Sugammadex sodium.

In another aspect, embodiments of the present invention provides process for preparation of Sugammadex sodium of Formula I, which comprises:
a) reacting gamma-cyclodextrin of Formula II

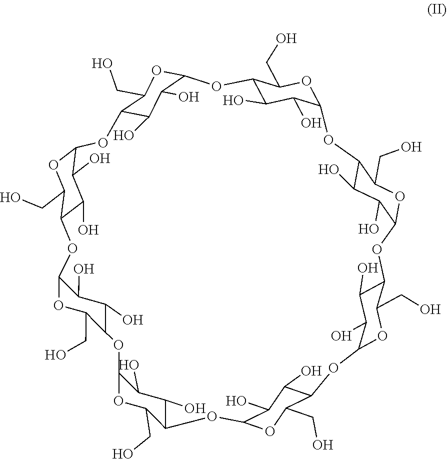 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]

with phosphorus pentachloride in dimethylformamide to obtain 6-perdeoxy-6-per-chloro gamma cyclodextrin of Formula III

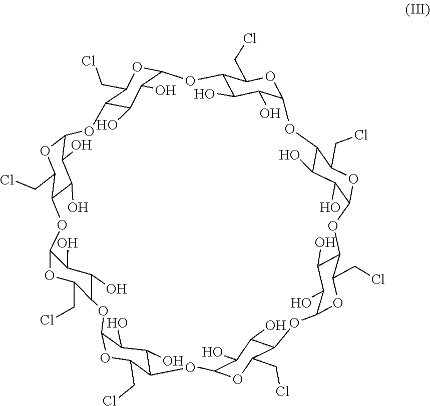 [SMILES: OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]

b) reacting compound of Formula III with 3-mercapto propionic acid of Formula IV

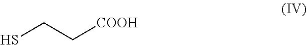

in dimethylformamide in the presence of 30% sodium methoxide in methanol to give Sugammadex Sodium of Formula I;
c) converting the obtained Sugammadex sodium into Sugammadex free acid of Formula V

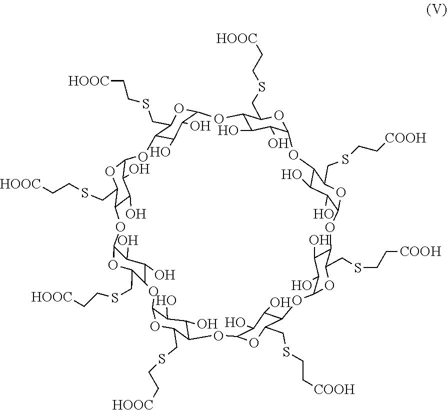 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

by adding acetic acid in the presence of water to obtain Sugammadex free acid;
d) purification of Sugammadex free acid obtained in step c) by preparative HPLC using silica column of C18 bulk media with 10 or 16 μm to obtain pure Sugammadex free acid in solution form;
e) distilling the obtained Sugammadex free acid solution in step d) to obtain solid pure Sugammadex free acid;
f) converting the obtained pure Sugammadex free acid obtained in step e) in to Sugammadex sodium by reacting Sugammadex free acid with sodium hydroxide in water;
g) purification of Sugammadex Sodium obtained in step f) using solvents selected from water, alcohols, DMF, dimethylacetamide, N-methylpyrrolidine, acetonitrile, DMSO or mixtures thereof to obtain pure Sugammadex sodium and
h) lyophilization of Sugammadex sodium obtained in step g) to obtain pure Sugammadex sodium.

In yet another aspect, embodiments of the present invention provides a process for preparation of Sugammadex sodium of Formula I, which comprises:
a) reacting gamma-cyclodextrin of Formula II

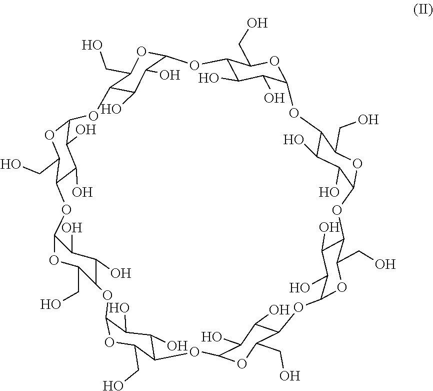 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]

with phosphorus pentachloride in dimethylformamide to give 6-perdeoxy-6-per-chloro gamma cyclodextrin of Formula III

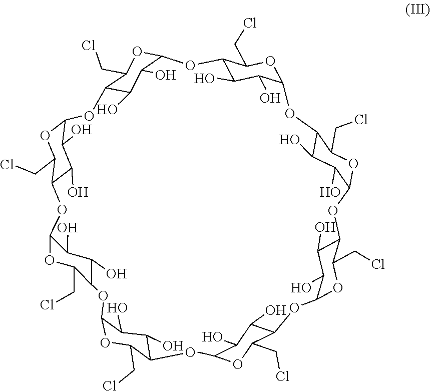 [SMILES: OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]

b) reacting compound of Formula III with 3-mercapto propionic acid of Formula IV

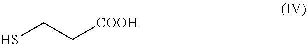

in dimethylformamide in the presence of 30% sodium methoxide in methanol to give Sugammadex Sodium of Formula I; and
c) purification of Sugammadex Sodium obtained in step b) using solvents selected from water, alcohols, DMF, dimethylacetamide, N-methylpyrrolidine, acetonitrile, DMSO or mixtures thereof to obtain pure Sugammadex sodium.

In yet another aspect, embodiments of the present invention provides a process for the purification of Sugammadex sodium by using the solvents such as water, alcohol, DMF, dimethylacetamide, N-methylpyrrolidine, acetonitrile, DMSO and the like or mixtures thereof.

In some embodiments, there is provided a process for the purification of Sugammadex sodium by using solvent selected from water or DMF or mixture thereof

In some embodiments of the invention, the 6-perdeoxy-6-per-chloro gamma cyclodextrin of Formula III is purified using solvents selected from water, acetonitrile, alcohols or mixtures thereof.

In yet another aspect, embodiments of the present invention provides a process for preparation of Sugammadex free acid of Formula V

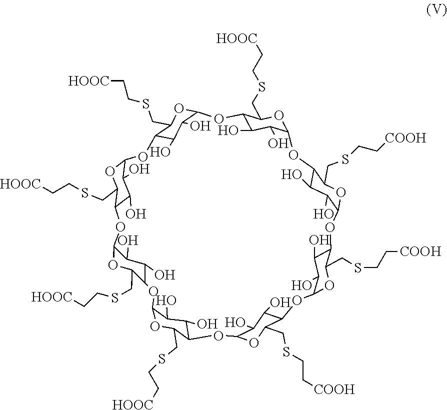 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

which comprises:
a) dissolving Sugammadex sodium of Formula I in water and adding acetic acid to obtain Sugammadex free acid of Formula V;
b) purification of Sugammadex free acid of Formula V obtained in step a) by preparative HPLC using silica column of C18 bulk media with 10 or 16 μm;
c) collecting the Sugammadex free acid of Formula V fraction in solution form and
d) distilling the collected fraction in step c) to obtain pure Sugammadex free acid of Formula V.

In yet another aspect, embodiments of the present invention provides a process for the purification of Sugammadex free acid by preparative HPLC using silica column of C18 bulk media with 10 or 16 μm.

In some embodiments of the invention, there is provided a process for the purification of Sugammadex free acid by preparative HPLC using silica column of C18 bulk media with 10 or 16 μm, wherein the preparative HPLC employs buffer as mobile phase A and acetonitrile or water or mixture thereof as mobile phase B.

In yet another aspect, there is provided a process for the preparation of Sugammadex sodium having purity greater than 99%.

In yet another aspect, there is provided a process for purification Sugammadex sodium, where in the Sugammadex sodium is obtained with purity greater than 99%.

In yet another aspect, embodiments of the present invention provides pure Sugammadex free acid having purity more than 99%.

In yet another aspect, embodiments of the present invention provides pure Sugammadex sodium having purity more than 99.5%.

### BRIEF DESCRIPTION

Some of the embodiments will be described in detail, with references to the following Figures, wherein like designations denote like members, wherein:

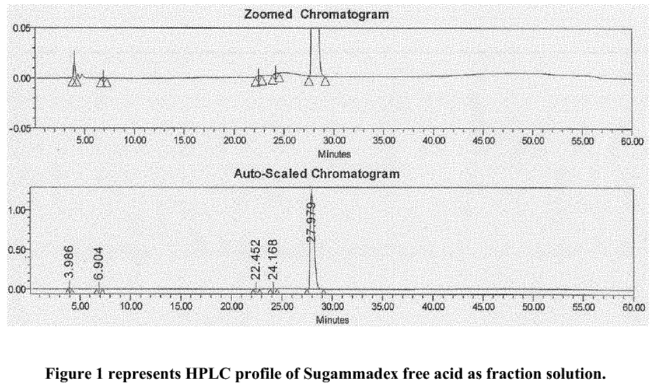

FIG. 1 represents HPLC profile of Sugammadex free acid as fraction solution;

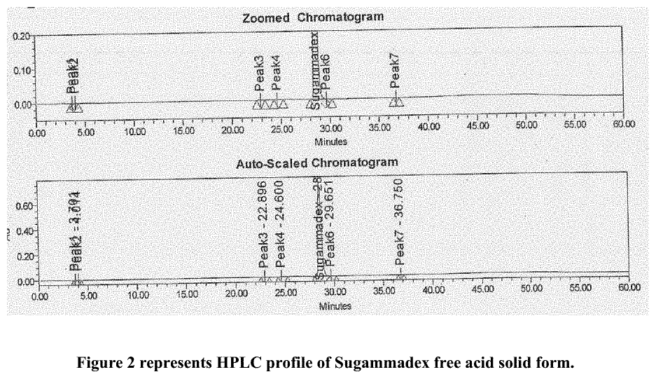

FIG. 2 represents HPLC profile of Sugammadex free acid solid form;

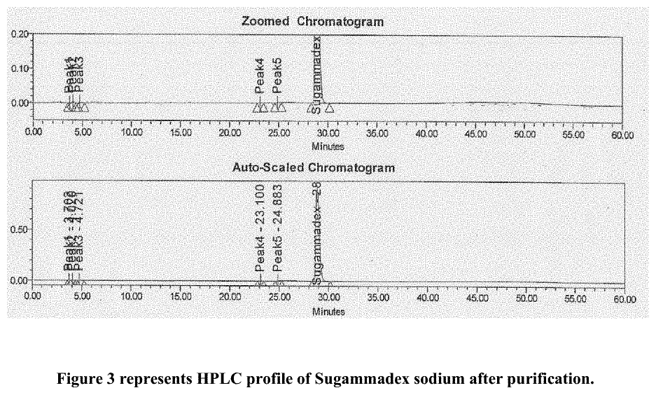

FIG. 3 represents HPLC profile of Sugammadex sodium after purification;

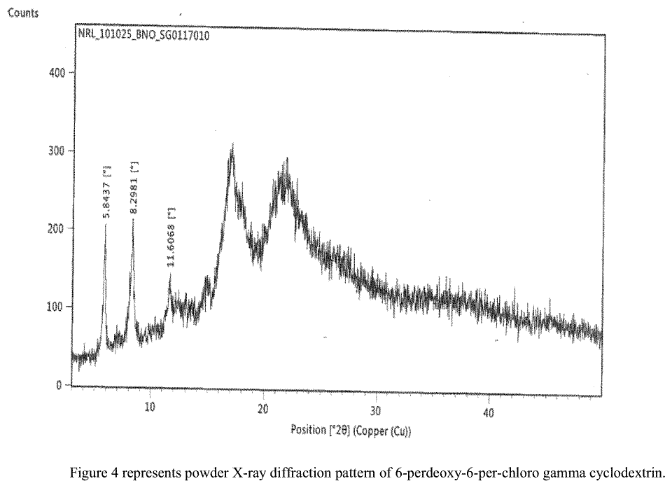

FIG. 4 represents powder X-ray diffraction pattern of 6-perdeoxy-6-per-chloro gamma cyclodextrin; and

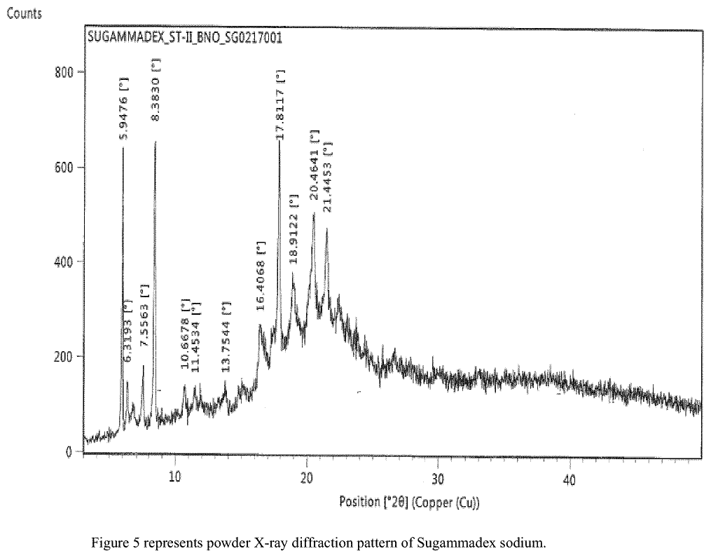

FIG. 5 represents powder X-ray diffraction pattern of Sugammadex sodium.

### DETAILED DESCRIPTION

Accordingly, embodiments of the present invention provides an improved process for the preparation of Sugammadex sodium.

Scheme 1 illustrates the process for preparation of Sugammadex sodium according to embodiments of the present invention:

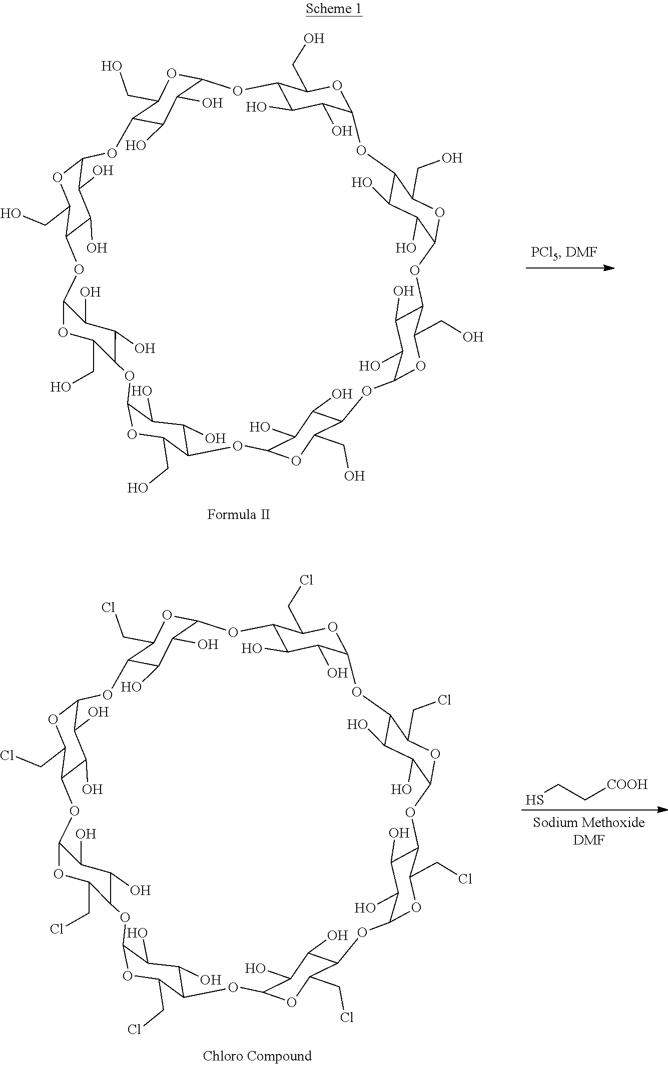 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O ; OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O ; O=C(O)CCS]

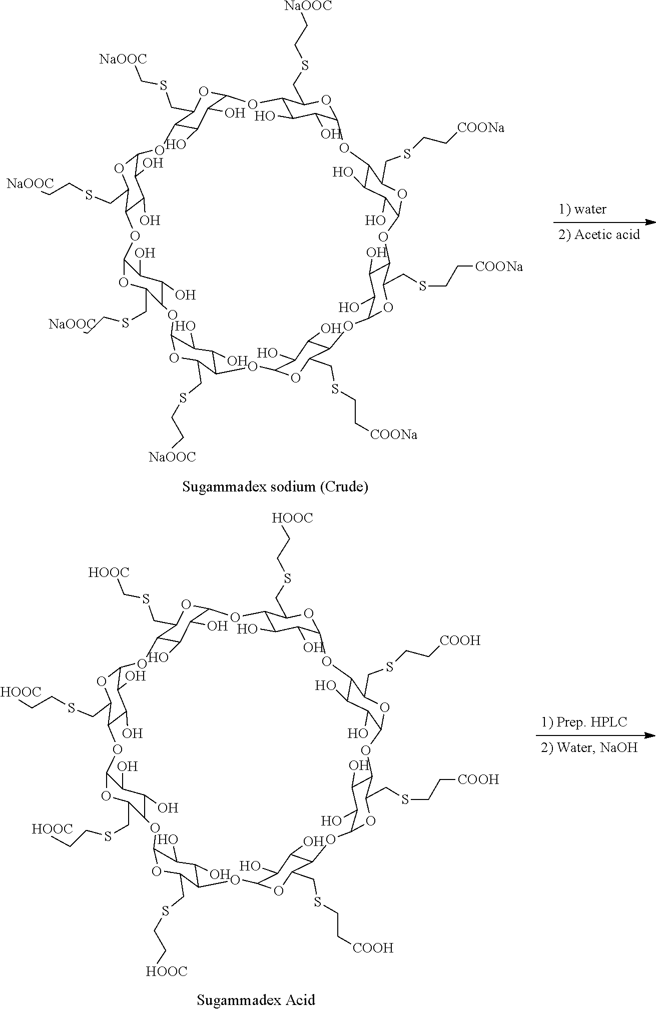

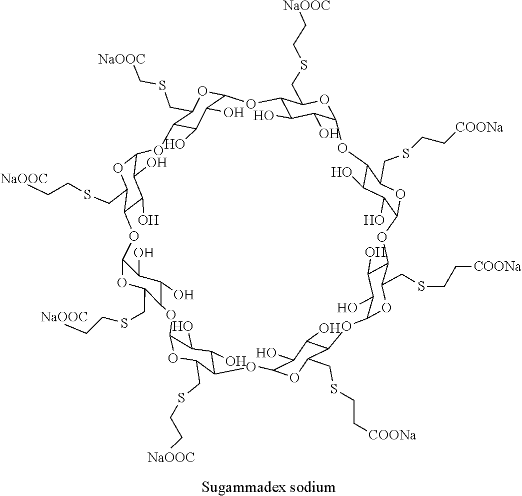

The first embodiment of the present invention provides a process for preparation of Sugammadex sodium of Formula I, which comprises:
a) reacting gamma-cyclodextrin of Formula II

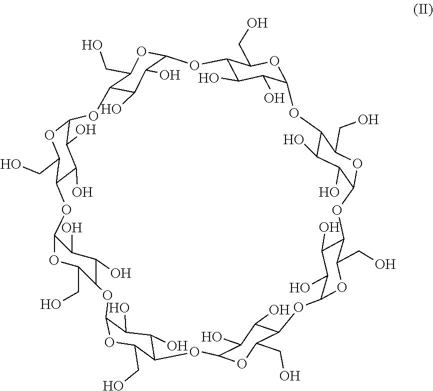 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]

with phosphorus pentachloride in dimethylformamide to obtain 6-perdeoxy-6-per-chloro gamma cyclodextrin of Formula III;

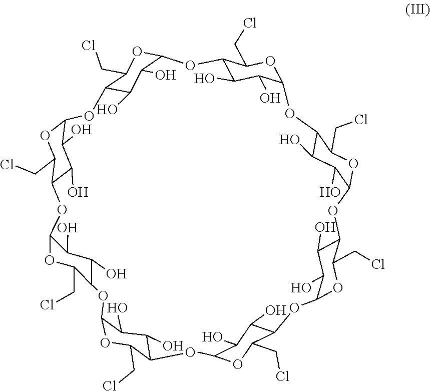 [SMILES: OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]

b) reacting compound of Formula III with 3-mercapto propionic acid of Formula IV

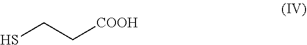

in dimethylformamide in the presence of 30% sodium methoxide in methanol to give Sugammadex Sodium of Formula I;
c) converting the obtained Sugammadex sodium into Sugammadex free acid of Formula V

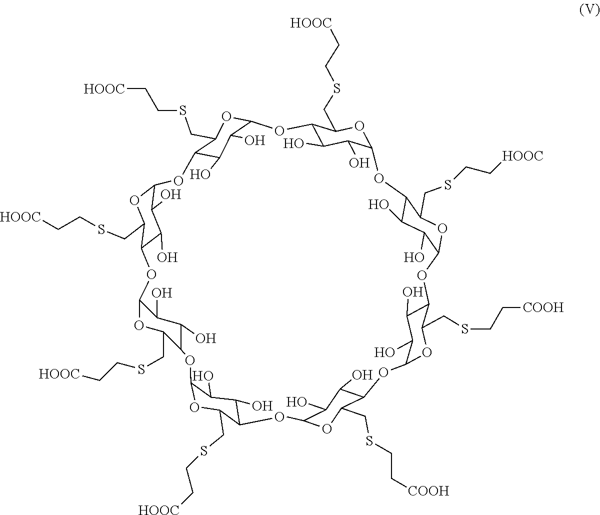 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

by adding acetic acid in the presence of water to obtain Sugammadex free acid;
d) purification of Sugammadex free acid obtained in step c) by preparative HPLC using silica column of C18 bulk media with 10 or 16 μm to obtain pure Sugammadex free acid in solution form;
e) distilling the obtained Sugammadex free acid solution in step d) to obtain solid pure Sugammadex free acid;
f) converting the obtained pure Sugammadex free acid obtained in step e) in to Sugammadex sodium by reacting Sugammadex free acid with sodium hydroxide in water and
g) lyophilization of Sugammadex sodium obtained in step f) to obtain pure Sugammadex sodium.

In another embodiment, the present invention provides a process for preparation of Sugammadex sodium of Formula I, which comprises:
a) reacting gamma-cyclodextrin of Formula II

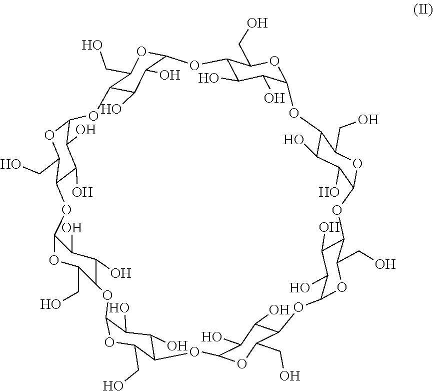 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]

with phosphorus pentachloride in dimethylformamide to obtain 6-perdeoxy-6-per-chloro gamma cyclodextrin of Formula III

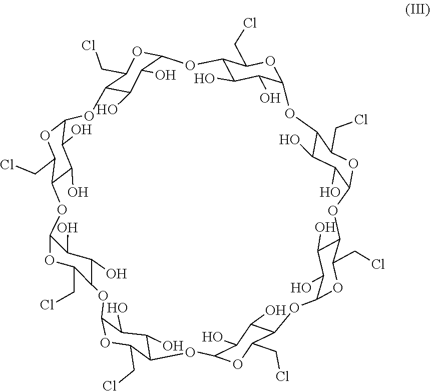 [SMILES: OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]

b) reacting compound of Formula III with 3-mercapto propionic acid of Formula IV

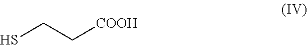

in dimethylformamide in the presence of 30% sodium methoxide in methanol to give Sugammadex Sodium of Formula I;
c) converting the obtained Sugammadex sodium into Sugammadex free acid of Formula V

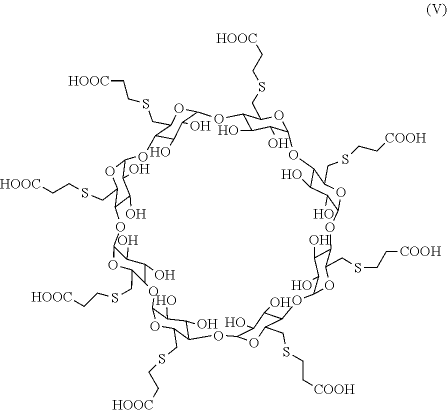 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

by adding acetic acid in the presence of water to obtain Sugammadex free acid;
d) purification of Sugammadex free acid obtained in step c) by preparative HPLC using silica column of C18 bulk media with 10 or 16 μm to obtain pure Sugammadex free acid in solution form;
e) distilling the obtained Sugammadex free acid solution in step d) to obtain solid pure Sugammadex free acid;
f) converting the obtained pure Sugammadex free acid obtained in step e) in to Sugammadex sodium by reacting Sugammadex free acid with sodium hydroxide in water;
g) purification of Sugammadex Sodium obtained in step f) using solvents selected from water, alcohols, DMF, dimethylacetamide, N-methylpyrrolidine, acetonitrile, DMSO or mixtures thereof to obtain pure Sugammadex sodium; and
h) lyophilization of Sugammadex sodium obtained in step g) to obtain pure Sugammadex sodium.

In a preferred embodiment, the present invention provides process for preparation of Sugammadex sodium of Formula I, which comprises:
a) reacting gamma-cyclodextrin of Formula II

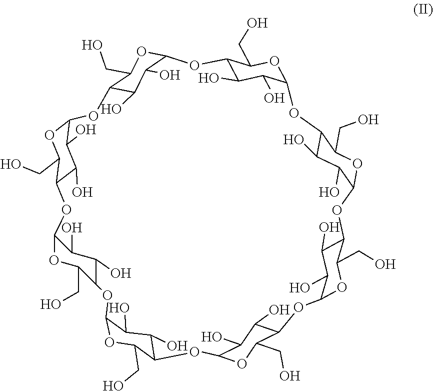 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]

with phosphorus pentachloride in dimethylformamide to give 6-perdeoxy-6-per-chloro gamma cyclodextrin of Formula III

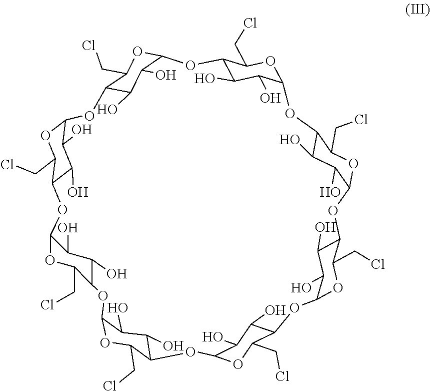 [SMILES: OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]

b) reacting compound of Formula III with 3-mercapto propionic acid of Formula IV

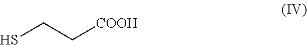

in dimethylformamide in the presence of 30% sodium methoxide in methanol to give Sugammadex Sodium of Formula I;
c) converting the obtained Sugammadex sodium into Sugammadex free acid of Formula V

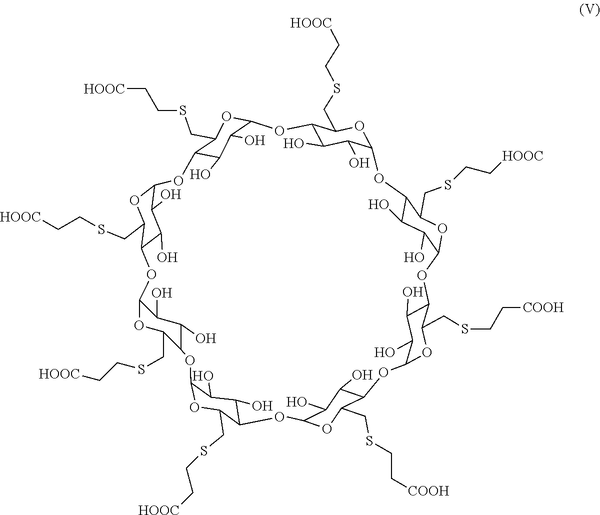 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

by adding acetic acid in the presence of water to obtain Sugammadex free acid;
d) purification of Sugammadex free acid obtained in step c) by preparative HPLC using silica column of C18 bulk media with 10 or 16 μm to obtain pure Sugammadex free acid in solution form;
e) distilling the obtained Sugammadex free acid solution in step d) to obtain solid pure Sugammadex free acid;
f) converting the obtained pure Sugammadex free acid obtained in step e) in to Sugammadex sodium by reacting Sugammadex free acid with sodium hydroxide in water;
g) purification of Sugammadex Sodium obtained in step f) using water or DMF or mixture thereof to obtain pure Sugammadex sodium and
h) lyophilization of Sugammadex sodium obtained in step g) to give pure Sugammadex sodium.

In some embodiments of the invention, the solvent used in step f) for the purification of Sugammadex sodium is mixture of water and DMF.

In yet another embodiment, the present invention provides a process for preparation of Sugammadex sodium of Formula I, which comprises:
a) reacting gamma-cyclodextrin of Formula II

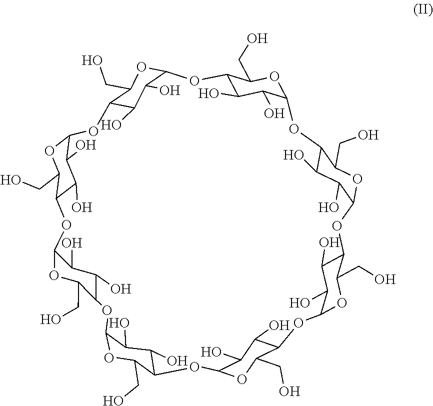 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]

with phosphorus pentachloride in dimethylformamide to obtain 6-perdeoxy-6-per-chloro gamma cyclodextrin of Formula III

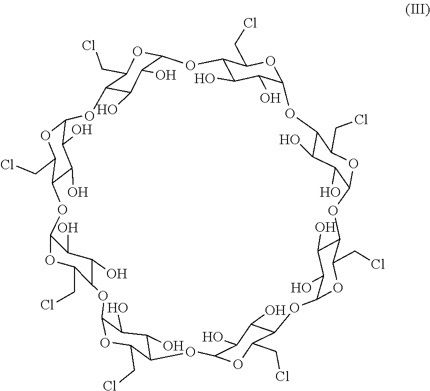 [SMILES: OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]

b) reacting compound of Formula III with 3-mercapto propionic acid of Formula IV

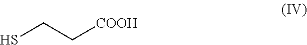

in dimethylformamide in the presence of 30% sodium methoxide in methanol to give Sugammadex Sodium of Formula I;
c) purification of Sugammadex Sodium obtained in step b) using solvents selected from water, alcohols, DMF, dimethylacetamide, N-methylpyrrolidine, acetonitrile, DMSO or mixtures thereof to obtain pure Sugammadex sodium.

In another preferred embodiment, the present invention provides a process for preparation of Sugammadex sodium of Formula I, which comprises:
a) reacting gamma-cyclodextrin of Formula II

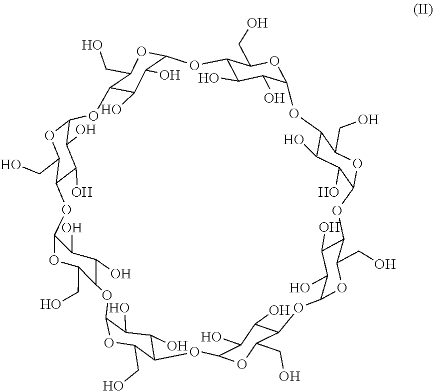 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]

with phosphorus pentachloride in dimethylformamide to give 6-perdeoxy-6-per-chloro gamma cyclodextrin of Formula III

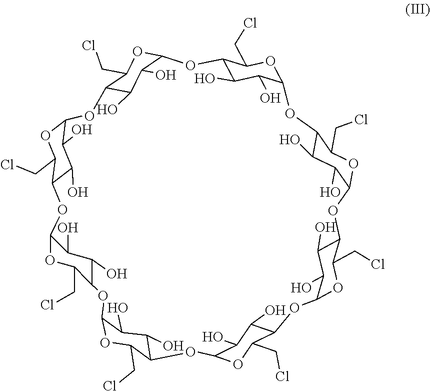 [SMILES: OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]

b) reacting compound of Formula III with 3-mercapto propionic acid of Formula IV

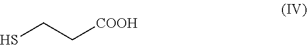

in dimethylformamide in the presence of 30% sodium methoxide in methanol to give Sugammadex Sodium of Formula I;
c) purification of Sugammadex Sodium obtained in step b) using mixture of water and DMF to obtain pure Sugammadex sodium.

In another embodiment, the present invention provides a process for the purification of 6-perdeoxy-6-per-chloro gamma cyclodextrin of Formula III

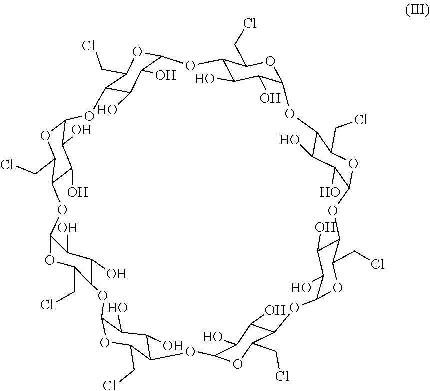 [SMILES: OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]

using solvents such as water, acetonitrile, alcohols or mixtures thereof.

The compound 6-perdeoxy-6-per-chloro gamma cyclodextrin of Formula III may be also be prepared by any of processes reported in literature, for example, according to the methods disclosed in Indian Patent Application Nos. 2459/CHE/2010 or 667/CHE/2013 which are incorporated herein by reference.

In yet another embodiment, the present invention provides a process for the purification of Sugammadex sodium using solvents such as water, alcohol, DMF, dimethylacetamide, N-methylpyrrolidine, acetonitrile, DMSO and the like or mixtures thereof. In some embodiment, there is provided a process for the purification of Sugammadex sodium using mixture of water and methanol.

Sugammadex sodium obtained in step (b) may be also be prepared by any of processes reported in literature, for example, according to the methods disclosed in Indian Patent Application Nos. 2459/CHE/2010 or 667/CHE/2013 which are incorporated herein by reference.

In yet another embodiment, the present invention provides a process for preparation of Sugammadex free acid of Formula V

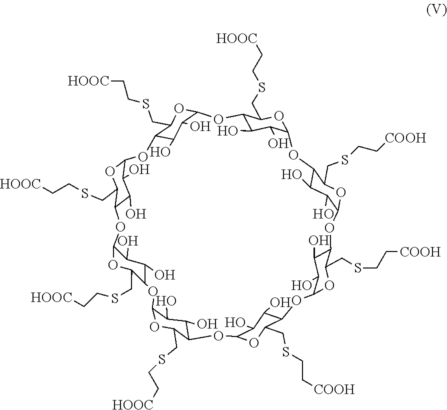 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

which comprises:
a) dissolving Sugammadex sodium of Formula I in water and adding acetic acid to obtain Sugammadex free acid of Formula V;
b) purification of Sugammadex free acid of Formula V obtained in step a) by preparative HPLC using silica column of C18 bulk media with 10 or 16 μm;
c) collecting the Sugammadex free acid of Formula V fraction in solution form and
d) distilling the collected fraction in step c) to obtain pure Sugammadex free acid of Formula V.

In yet another embodiment, the present invention provides a process for the purification of Sugammadex free acid by preparative HPLC using silica column of C18 bulk media with 10 or 16 μm.

In some embodiments of the invention, there is provided a process for the purification of Sugammadex free acid by preparative HPLC using silica column of C18 bulk media with 10 or 16 μm, wherein the preparative HPLC employs buffer as mobile phase A and acetonitrile or water or mixture thereof as mobile phase B.

In yet another aspect, there is provided a process for the preparation of Sugammadex sodium having purity greater than 99%.

In yet another aspect, there is provided a process for purification Sugammadex sodium, where in the Sugammadex sodium is obtained with purity greater than 99%

In yet another embodiment, the present invention provides pure Sugammadex free acid having purity more than 99%.

In yet another embodiment, the present invention provides Sugammadex sodium having purity more than 99.5%.

In some embodiments of the invention, the purified 6-perdeoxy-6-per-chloro gamma cyclodextrin of Formula III is characterized by X-ray powder diffraction (XRPD) pattern having peaks at 5.84, 8.30, 11.61±0.2 degrees 2 theta.

In some embodiments of the invention, there is provided a process for the preparation of Sugammadex sodium of Formula I characterized by X-ray powder diffraction (XRPD) pattern having peaks at 5.95, 6.32, 7.56, 8.38, 10.67, 11.45, 13.75, 16.41, 17.81, 18.91, 20.46, 21.44±0.2 degrees 2 theta.

In some embodiments of the invention, there is provided a process for the preparation of Sugammadex sodium of Formula I characterized by X-ray powder diffraction (XRPD) pattern having peaks at 5.95, 8.38, 17.81, 20.46, 21.44±0.2 degrees 2 theta.

In another embodiment of the invention, there is provided a process for purification of Sugammadex sodium of Formula I, wherein obtained Sugammadex sodium is characterized by X-ray powder diffraction (XRPD) pattern having peaks at 5.95, 6.32, 7.56, 8.38, 10.67, 11.45, 13.75, 16.41, 17.81, 18.91, 20.46, 21.44±0.2 degrees 2 theta.

In another embodiment of the invention, there is provided a process for purification of Sugammadex sodium of Formula I, wherein obtained Sugammadex sodium is characterized by X-ray powder diffraction (XRPD) pattern having peaks at 5.95, 8.38, 17.81, 20.46, 21.44±0.2 degrees 2 theta.

### EXAMPLES

The details of embodiments of the invention are given in the examples provided below, which are given to illustrate embodiments of the invention only and therefore should not be construed to limit the scope of embodiments of the invention.

### Example 1

### Preparation of 6-perdeoxy-6-per-chloro Gamma Cyclodextrin

Phosphorus pentachloride (565 grams) was added slowly to dimethylformamaide (DMF) (2200 mL) under nitrogen atmosphere at 25-40° C. Stirred the reaction mixture at 25-40° C. for 1 hour. Gamma-cyclodextrin (220 grams) was added lot wise into above reaction mixture at 25-50° C. The temperature of the reaction mass was raised to 65-70° C. and stirred the reaction at this temperature for 28 hours. The reaction mixture was cooled to 0-10° C. and quenched with pre-cooled water (3520 mL). Adjusted the pH of the reaction mass to 10.0-12.0 with 30% sodium methoxide in methanol at 25-40° C. and maintained the reaction mass at this temperature for 2 hours. The reaction mass was filtered under vacuum and washed with water (440 mL) and suck dried for 30 minutes to yield titled compound as wet material (1700 grams).

### Example 2

### Purification of 6-perdeoxy-6-per-chloro Gamma Cyclodextrin

Purified water (6600 mL) was added to the wet compound (1700 gram) obtained in Example-1. Heated the reaction mass to 60-65° C. and maintained the reaction at this temperature for 2 hours. Filtered the reaction mass, washed with water (440 mL) and dried the compound to yield 211 grams of the title compound.

### Example 3

### Preparation of Sugammadex Sodium

Mixture of 3-mercapto propionic acid (220 grams) and DMF (400 mL) was added to 30% solution of sodium methoxide in methanol (746 grams) at 25-35° C. and stirred the reaction mass for about 1.5 hours at the same temperature. The compound from example-1 (200 grams) in DMF (1500 mL) was added to the reaction mixture at 25-35° C., heated the reaction mass to 75-80° C. and maintained at the same temperature for about 75-80° C. for 24 hours. After completion of the reaction, the reaction mass was cooled to 25-35° C., methanol (2000 mL) was added to the reaction mass and stirred for 1 hour at the same temperature. The resultant solid was filtered, washed with methanol (800 mL) and dried at 55-60° C. for 12 hours to yield 460 grams of the title compound.

### Example 4

### Purification of Sugammadex Sodium

Mixture of purified water (690 mL) and methanol (690 ml) was added to the crude compound (460 grams) obtained in Example-3 at 25-35° C. and stirred the reaction mass at the same temperature until the formation of clear solution. Activated carbon (115 grams) and added to the above reaction mass at 25-35° C. and stirred for 30 minutes. Filtered the reaction mass on hyflow bed, washed the cake with purified water (230 mL) and methanol (230 mL) and suck dried for 30 minutes. Methanol (5980 ml) was added to the above filtrate at 25-35° C. and stirred the reaction mass at the same temperature for 2 hours. Filtered the obtained solid, washed with methanol (1840 mL) and dried under hot air oven at 55-60° C. for 14 hours to obtain 240 grams of the title compound.

### Example 5

### Purification of Sugammadex Sodium

DMF (6 L) was added to the dry compound obtained in Example-4 at 25-35° C. and stirred for dissolution. Heated the reaction mass to 85-90° C., purified water (2400 mL) was added and stirred the reaction mass for 30 minutes at the same temperature. Slowly cooled the reaction mass to 25-35° C. and stirred at the same temperature for 12 hours. Filtered the obtained solid, washed with methanol (960 mL) and dried under hot air oven at 55-60° C. for 8 hours to obtain 176 grams of the title compound.

### Example 6

### Purification of Sugammadex Sodium

To the compound (176 grams) obtained in Example-5 purified water (528 mL) was added and stirred the reaction mass for dissolution. pH of the reaction mass adjusted to 7.0-7.5 with hydrochloric acid (7 mL in purified water 45 mL) at 25-35° C. and stirred the reaction mass for 15 minutes at the same temperature. Filtered the contents, washed with water (88 mL) and suck dried for 15 minutes. To the filtrate (820 mL) thus obtained was added methanol (6160 mL) at 25-35° C. and stirred the reaction for 1 hour at the same temperature. Filtered the solid obtained, washed with methanol (704 mL), dried under hot air oven at 55-60° C. for 10 hours to obtain 154 grams of the title compound.

### Example 7

### Purification of Sugammadex Sodium

Methanol (1.5 L) was added to the crude compound (150 grams) obtained in Example-6 at 25-35° C. and stirred the reaction mass at the same temperature for 10 minutes. Heated the reaction mass to 60-65° C. and purified water (450 mL) was added at the same temperature. Methanol (2250 mL) was added slowly to the reaction mass at 60-65° C. and stirred the reaction mass for 1 hour ate the same temperature. Cooled the reaction mass to 25-35° C. and stirred at the same temperature for 2 hours. Filtered the solid obtained, washed with methanol (600 mL), dried under hot air oven at 55-60° C. for 10 hours to obtain 121 grams of the title compound.

### Example 8

### Preparation of Sugammadex Free Acid

Sugammadex sodium obtained in Example-7 was dissolved in water (11.25 volumes) and 6.5 equivalents of acetic acid was added. Stirred the mixture and sonicated the sample for 5 minutes, injected the sample in silica column of C18 bulk media with 10 or 16 μm and collected the Sugammadex free acid fraction in solution form. The collected Sugammadex free acid fraction was distilled below 60° C. to obtain pure Sugammadex free acid.

### Example 9

### Preparation of Sugammadex Sodium

Water (200 mL) was added to the Sugammadex acid obtained in Example-7 at 25-35° C. and stirred for dissolution. pH of the reaction mass was adjusted to 9.0-9.5 with sodium hydroxide solution (NaOH flakes 14.7 grams in purified water 60 mL) at 25-35° C. and stirred the reaction mass for 15 minutes. pH of the reaction mass was adjusted to 7.0 to 7.5 with hydrochloric acid solution (15 mL HCl dissolved in purified water 60 mL) at 25-35° C. and stirred the reaction for 10 minutes. Activated carbon (5.0 grams) was added to the reaction mass at 25-35° C. and stirred the reaction at the same temperature for 15 minutes. Filtered the carbon, washed the bed with purified water (50 mL). The filtrate thus obtained was subjected to lyophilization to get 84 grams of pure Sugammadex sodium.

### Example 10

### Preparation of Sugammadex Sodium

Sugammadex free acid obtained from the above Example-8 was is dissolved in water and neutralized by using aqueous sodium hydroxide solution. Methanol (30 volume) was added to the resulting reaction mixture at 25-30° C. and stirred for 1 hour at the same temperature. The resulting reaction mixture was filtered and washed with methanol. The obtained wet compound was dissolved in a mixture of methanol (9.5 volume) and water (0.5 volume). The resulting reaction mixture was stirred for 1 hour at 25-30° C. Filtered the precipitated solid and washed with methanol. The obtained compound was dissolved in water at 25-30° C. and lyophilized to get the titled compound.

### Example 11

### Preparation of Sugammadex Sodium

Sugammadex free acid obtained from the above Example-8 was dissolved in water and neutralized by using aqueous sodium hydroxide solution. Methanol (30 volumes) was added to the resulting reaction mixture at 25-30° C. and stirred for 1 hour at the same temperature. The resulting reaction mixture was filtered and washed with methanol. The obtained wet compound was dissolved in a mixture of DMF (25 volumes) and water (10 volumes). The resulting reaction mixture was stirred for 1 hour at 25-30° C. Filtered the precipitated solid and washed with methanol. The obtained compound was dissolved in water at 25-30° C. and lyophilized to get the title compound.

The obtained purified Sugammadex sodium was analyzed by chromatography and X-Ray powder diffraction techniques:

Conditions for Chromatography (HPLC):

The detailed chromatographic conditions were mentioned below:
Column: DAC Axial Compressor Column with 27 Cm length×15 Cm internal ID with Kromosil Silica 16 Micron stationary phase
Wavelength (nm): 210 nm
Buffer: 10 mM Ammonium formate (0.01% Acetic Acid) in water
Mobile phase-A: Buffer only
Mobile phase-B: Acetonitrile: Water (80:20 v/v)
Flow Rate: 600 mL/minute
Run time: 120 minutes
Mode: Gradient

Reagents:
i. Ammonium formate
ii. Acetonitrile
iii. Acetic Acid
iv. Milli-Q-Water.

Buffer: 10 mM Ammonium formate (0.01% Acetic Acid)
[For 50 L of water take 31.5 g of Ammonium formate& 5 ml of Acetic Acid]
Mobile Phase A: Buffer only
Mobile phase B: Acetonitrile:Water (80:20 v/v)
Mobile phase C: Washing solvent—Acetonitrile:Water (60:40 v/v)
Diluent: Water & Acetic acid

Sugammadex Free Acid Peak Retention Time: 40-45 minutes at 210 nm.

The above chromatographic conditions can be applied to 3 Kg by using silica of made of YMC Triart (or) Chromosil C18 bulk media with 10 (or) 16 uM.

The FIG. 1 represents HPLC profile of Sugammadex free acid as fraction solution.

The FIG. 2 represents HPLC profile of Sugammadex free acid solid form.

The FIG. 3 represents HPLC profile of Sugammadex sodium after purification.

The purified Sugammadex sodium and 6-perdeoxy-6-per-chloro gamma cyclodextrin of Formula III were analyzed for powder X-ray diffraction pattern.

FIG. 4 represents powder X-ray diffraction pattern of 6-perdeoxy-6-per-chloro gamma cyclodextrin having peaks at 5.84, 8.30, 11.61±0.2 degrees 2 theta.

FIG. 5 represents powder X-ray diffraction pattern of Sugammadex sodium having peaks at 5.95, 6.32, 7.56, 8.38, 10.67, 11.45, 13.75, 16.41, 17.81, 18.91, 20.46, 21.44±0.2 degrees 2 theta.

Although the invention has been illustrated and described in greater detail with reference to the preferred exemplary embodiments, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1-10. (canceled)

11. A process for preparation of Sugammadex sodium of Formula I, which comprises:
a) reacting gamma-cyclodextrin of Formula II 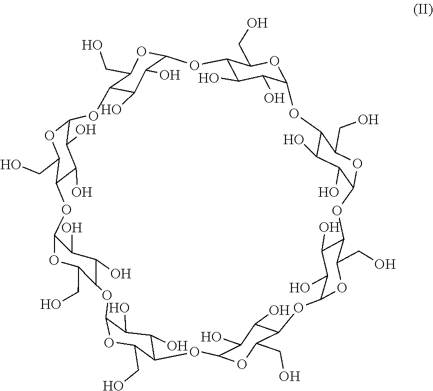 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]
with phosphorus pentachloride in dimethylformamide to give 6-perdeoxy-6-per-chloro gamma cyclodextrin of Formula III 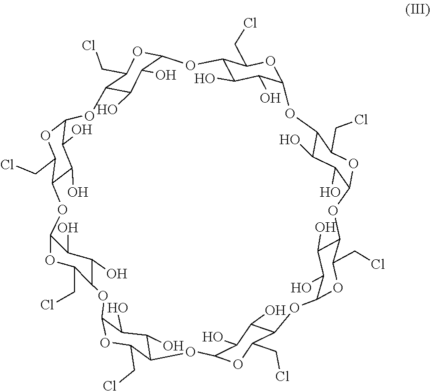 [SMILES: OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]
b) reacting compound of Formula III with 3-mercapto propionic acid of Formula IV 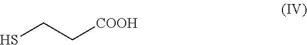
in dimethylformamide in the presence of 30% sodium methoxide in methanol to give Sugammadex Sodium of Formula I;
c) converting the obtained Sugammadex sodium into Sugammadex free acid of Formula V 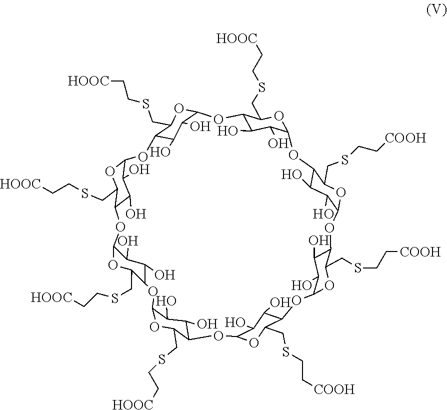 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]
by adding acetic acid in the presence of water to obtain Sugammadex free acid;
d) purification of Sugammadex free acid obtained in step c) by preparative HPLC using silica column of C18 bulk media with 10 or 16 μm to obtain pure Sugammadex free acid in solution form;
e) distilling the obtained Sugammadex free acid solution in step d) to obtain solid pure Sugammadex free acid;
f) converting the obtained pure Sugammadex free acid obtained in step e) in to Sugammadex sodium by reacting Sugammadex free acid with sodium hydroxide in water;
g) purification of Sugammadex Sodium obtained in step f) using solvents selected from water, alcohols, DMF, dimethylacetamide, N-methylpyrrolidine, acetonitrile, DMSO or mixtures thereof to obtain pure Sugammadex sodium and
h) lyophilization of Sugammadex sodium obtained in step g) to give pure Sugammadex sodium.

12. The process according to claims 11, wherein 6-perdeoxy-6-per-chloro gamma cyclodextrin obtained in step a) is subjected to purification using solvents selected from water, acetonitrile, alcohols or mixtures thereof.

13. A process for purification of Sugammadex Sodium wherein the solvents used for purification are selected from water, alcohols, DMF, dimethylacetamide, N-methylpyrrolidine, acetonitrile, DMSO or mixtures thereof.

14. The process according to claim 13, wherein the solvents used for purification are selected from water and DMF.

15. A process for preparation of Sugammadex free acid of Formula V 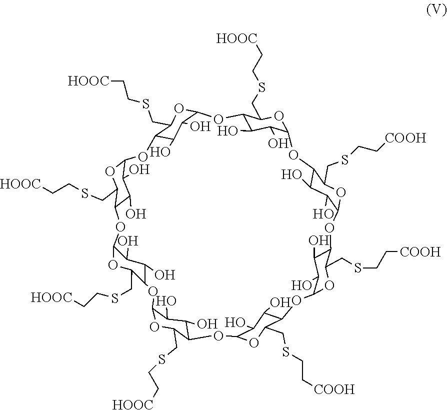 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]
which comprises:
a) dissolving Sugammadex sodium of Formula I in water and adding acetic acid to obtain Sugammadex free acid of Formula V;
b) purification of Sugammadex free acid of Formula V obtained in step a) by preparative HPLC using silica column of C18 bulk media with 10 or 16 μm;
c) collecting the Sugammadex free acid of Formula V fraction in solution form and
d) distilling the collected fraction in step c) to obtain pure Sugammadex free acid of Formula V.

16. A process for the purification of Sugammadex free acid by preparative HPLC using silica column of C18 bulk media with 10 or 16 μm.

17. The process according to claim 16, wherein the mobile phase A is buffer and mobile phase B is Acetonitrile and Water.
